(19) United States
(12) Patent Application Publication
(10) Pub. No.: US 2013/0104342 A1
(43) Pub. Date: May 2, 2013

(54) MOBILE TERMINAL

(71) Applicant: Tatsuya SANO, Tokyo (JP)

(72) Inventor: Tatsuya SANO, Tokyo (JP)

(73) Assignee: Sony Mobile Communications Japan, Inc., Tokyo (JP)

(21) Appl. No.: 13/572,056

(22) Filed: Aug. 10, 2012

Related U.S. Application Data
(60) Provisional application No. 61/552,312, filed on Oct. 27, 2011.

(51) Int. Cl. E05F 1/12; E05D 11/10; E05F 1/16

(52) U.S. Cl. 16/297

(57) ABSTRACT

A mobile terminal including first and second cases, and a hinge shifting the first and second cases between open and closed states. The hinge including a slide hinge including a movable plate, and a support plate secured to the second case that slidably supports the movable plate. The hinge further including a rotation hinge including a fixed part secured to the first case; a rotational part rotatable on an axis common with the fixed part; an elastic member providing the rotational part with a force to rotate the rotational part with respect to the fixed part; a link mechanism connecting the rotational part with the movable plate; and a locking member locking rotation of the rotational part with respect to the fixed part. The support plate including a rotation actuating part that unlocks the locking member so that the rotational part rotates with respect to the fixed part.

### CROSS REFERENCE TO RELATED APPLICATION

The present application claims the benefit of the earlier filing date of U.S. Provisional Patent Application Ser. No. 61/552,312 filed on Oct. 27, 2011, the entire contents of which is incorporated herein by reference.

### BACKGROUND

1. Field of the Disclosure

The present disclosure relates to a mobile terminal having a first case and a second case that can be opened and closed by linking a slide operation and a rotational operation together and to a rotational hinge used in the mobile terminal.

2. Description of Related Art

Mobile terminals typified by mobile phone terminals have come into widespread use in these days, and improvement of their portability, display visibility, and convenience is being pursued.

Known types of mobile terminals include a straight type in which a single case is used, a clamshell type in which a first case and a second case are mutually linked by a hinge to enlarge a display screen, and a slide type.

Recent mobile terminals called smart phones use a touch screen formed by overlaying a touch area on a display screen to eliminate a hardware numeric keypad, enabling the surface of the case to be substantially entirely used as the display screen.

In response to this trend, new types of mobile terminals are being studied to further enlarge the display screen size without the sacrifice of portability. Each of these new types of mobile terminals uses a first case and a second case, each of which has a display screen on its substantially entire surface. With the two cases closed (that is, in a closed posture), the second case, which is the upper case, is overlaid on the display screen of the first case, which is the lower case, with the display screen of the second case facing up. To place the two cases in an open state (that is, in a open posture), the second case is slid in parallel to the first case and the two cases are placed side by side so that the surfaces of display screens of the two cases are made to be flush with each other.

In the above structure, the projected area of the two cases in the closed state of the mobile terminal is equal to the area of one case when viewed from above. Although the thickness of the mobile terminal is slightly increased, the mobile terminal can have the same portability as conventional mobile terminals. In the open state, the two cases are placed side by side and the surfaces of the display screens of the two cases become flush with each other, enabling the two display screens to be used as if they were a large screen device with a double size.

To achieve the above open and close operations, a mechanism for linking the two cases needs a hinge that enables a complex operation in which a slide operation and a rotational operation are combined together.

As for a conventional slide operation, a slide hinge module that uses an elastic spring to support a slide operation performed by a user for a case with the elastic force of the elastic spring is proposed (see Japanese Unexamined Patent Application Publication No. 2010-279015). This module relates to a mobile telephone terminal that is slidably opened and closed by sliding an upper case having a display part, with respect to a lower case on which a keyboard is placed. The slide hinge module, which links the lower case and upper case together, is formed with a fixed plate and a movable plate slidably linked to the fixed plate with an elastic spring provided between the two plates. The elastic spring provides an elastic force so that, when the movable plate slides with respect to the fixed plate, the movable plate can be semiautomatically operated. More specifically, during the sliding of the movable plate, the movable plate is slid by an external force generated by the user until a dead point is reached. When the movable plate moves beyond the dead point, however, it automatically moves toward an end of the opposite side with the dead point taken as a boundary, due to the elastic force of the elastic spring. If the external force is removed before the movable plate reaches the dead point, the movable plate automatically moves back to the original end. Accordingly, the mobile terminal shifts to one of the stable states, open state and closed state.

As for a rotational operation, a rotational hinge formed with a movable cam, a fixed cam, and an invertible cam, which are attached to the same shaft, is proposed for clamshell-type mobile terminals (see Japanese Unexamined Patent Application Publication No. 2003-214423). This rotational hinge, in which the movable cam, fixed cam, and invertible cam are mutually disposed at predetermined rotational angles, has a lock mechanism that locks the rotation of the movable cam through the fixed cam. When a knob provided for the lock mechanism is rotated by the user, the lock mechanism is released and a spring force causes the movable cam to rotate so as to follow the invertible cam. In this structure, the mobile terminal then automatically shifts from the closed state to the open state by being triggered by an actuation manipulation performed by the user. In addition, when the clamshell-type mobile terminal is in the closed state, the upper case has no backlash for the lower case.

However, the slide hinge and rotational hinge described above are independent devices, and an operation in which a slide operation and a rotational operation are linked together is not considered for these devices.

Japanese Unexamined Patent Application Publication No. 2009-059102 proposes a hinge through which a mobile information terminal having a first case on which a keyboard is placed and a second case on which an output screen is exposed performs a complex operation in which the slide operation and rotational operation of the two cases are combined together.

### SUMMARY

From the viewpoint of users' convenience, it is desirable that even hinges that perform this complex operation not only achieve a slide operation and a rotational operation between the first case and the second case but also can more simplify open and close operations, particularly, an open operation.

The inventor in this application is aware of the need of the ability for a mobile terminal to shift from the closed state to the open state as a series of continuous operations, which are a slide operation biased by an elastic force and a rotational operation, in response to an actuation manipulation performed by the user.

According to an embodiment of the present disclosure, there is provided a mobile terminal including first and second cases, and a hinge that shifts the first and second cases between open and closed states. The hinge including a slide hinge including a movable plate, and a support plate secured to the second case and that slidably supports the movable plate. The hinge module further including a rotation hinge including a fixed part secured to the first case; a rotational part rotatable on an axis common with the fixed part; an elastic member providing the rotational part with a biased force to rotate the rotational part with respect to the fixed part; a link mechanism that connects the rotational part with the movable plate; and a locking member that locks the rotation of the rotational part with respect to the fixed part at a predetermined angle. The support plate including a rotation actuating part that unlocks the locking member so that the rotational part rotates with respect to the fixed part.

### BRIEF DESCRIPTION OF DRAWINGS

FIGS. 1A, B, and C illustrate the appearance of a mobile terminal according to an embodiment of the present disclosure.

FIG. 2 illustrates a positional relationship among a first case, a second case, and a complex hinge module of the mobile terminal illustrated in FIG. 1.

FIG. 3 is an exploded perspective view of the complex hinge module illustrated in FIG. 2.

FIG. 4 is a perspective view of the complex hinge module in which the disassembled parts in FIG. 3 have been assembled, as viewed from the back of the complex hinge module.

FIGS. 5A to 5C are schematic views generally illustrating the operation of the slide hinge illustrated in FIG. 4.

FIG. 6A illustrates a graph representing a relationship between the position Y of a movable plate with respect to a support plate and the elastic force (repulsive force) of each spring member, and FIG. 6B illustrates a graph representing a relationship between the position Y and a biased force Fy, in the Y-axis direction, which is exerted on the movable plate due to the elastic force.

FIG. 7 is a perspective view of major parts of the complex hinge module in which the disassembled parts in FIG. 3 have been assembled, as viewed from a side.

FIGS. 8A and 8B illustrate a structure in which a movable part, two arm members, and a rotational hinge are connected together.

FIG. 9 is an external view of a structure in which an arm member is linked to the rotational hinge illustrated in FIG. 4.

FIG. 10 is a perspective view showing the appearance of the rotational hinge illustrated in FIG. 4.

FIG. 11 is an exploded perspective view in which the parts constituting the rotational hinge shown in FIG. 10 are disassembled.

FIGS. 12A to 12F are six-plane views illustrating the appearance of the sliding cam of the rotational hinge.

FIGS. 13A to 13F are six-plane views illustrating the appearance of the rotor of the rotational hinge.

FIGS. 14A to 14F are six-plane views illustrating the appearance of the rotational cam of the rotational hinge.

FIG. 15 is an external view of the rotational hinge from which a fixed housing and a movable housing have been removed.

FIG. 16 is a gray-scale view that stereoscopically illustrates the rotational hinge illustrated in FIG. 15.

FIGS. 17A to 17C are external views illustrating a shift starting from the locked state of the rotational hinge.

FIGS. 18A and 18B are external views illustrating a shift in which the rotational hinge returns from the state in FIG. 17C to the locked state.

FIG. 19 is a schematic view that two-dimensionally illustrates a relationship among the main constituent components of the rotational hinge.

FIGS. 20A to 20D illustrate processes taken when a first stable state of the rotational hinge, which corresponds to a locked state, is shifted to a second stable state of the rotational hinge after the lock is released.

FIGS. 21A to 21D illustrate processes taken when the second stable state of the rotational hinge is shifted back to the first stable state corresponding to the original locked state.

FIG. 22A to 22G illustrate smooth linkage between the slide operation of the slide hinge and the rotational operation of the rotational hinge when the mobile terminal in the embodiment of the present disclosure shifts from a closed state to an open state.

FIGS. 23A to 23D illustrate operations in the shift of the mobile terminal in this embodiment from the open state to the closed state.

### DETAILED DESCRIPTION

An embodiment of the present disclosure will be described below in detail with reference to the drawings.

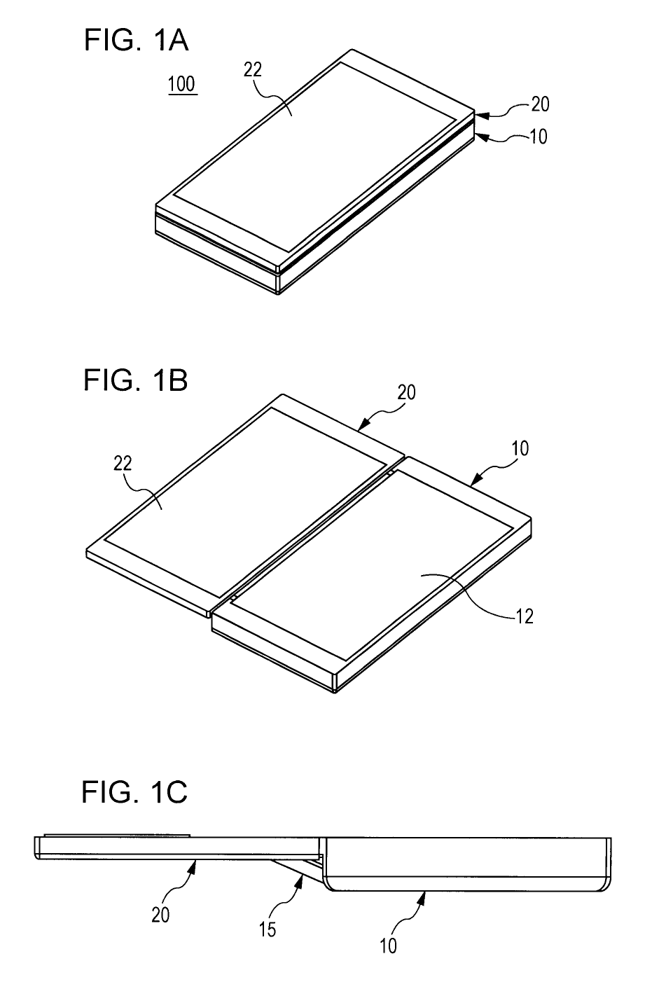

FIG. 1 illustrates the appearance of a mobile terminal 100 according to an embodiment of the present disclosure. FIG. 1A is a perspective view of the mobile terminal placed in a closed state, FIG. 1B is a perspective view of the mobile terminal placed in an open state, and FIG. 1C is a side view of the mobile terminal placed in the open state.

The mobile terminal 100 has a first case 10, shaped like a substantially flat plate, which has a display screen 12 exposed on its front surface as a functional part, and also has a second case 20, shaped like a substantially flat plate, which has a display screen 22 exposed on its front surface as a functional part. In this example, the first case 10 is used as the lower case and the second case 20 is used as the upper case. When the mobile terminal 100 is in the closed state illustrated in FIG. 1A, the rear surface of the second case 20 is overlaid on the front surface of the first case 10. That is, the second case 20 is placed on the first case 10 with its display screen 22 facing up so as to cover the display screen 12 of the first case 10. When the mobile terminal 100 in the open state illustrated in FIGS. 1B and 1C, the first case 10 and second case 20 are placed side by side with the surfaces of their display screen 12 and display screen 22 being flush with each other.

The first case 10 and second case 20 are linked together by a complex hinge module 15. The structure and operation of the complex hinge module 15 will be described below in detail.

At least one of the display screen 12 of the first case 10 and the display screen 22 of the second case 20 is preferably a touch screen that accepts touch manipulations made by the user. When the terminal is in the open state, the opposing edges of the display screen 12 and display screen 22 are brought close together as much as possible and the display screen 12 and display screen 22 thereby function as if they were a single display screen.

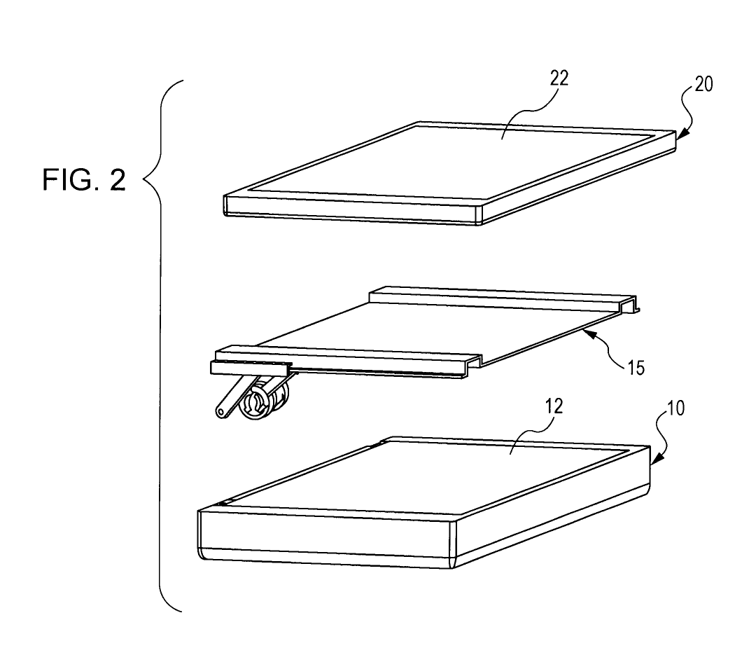

FIG. 2 illustrates a positional relationship among the first case 10, second case 20, and complex hinge module 15 of the mobile terminal 100. The mobile terminal 100 is structured by placing the complex hinge module 15 between the first case 10 and the second case 20 with their display screen 12 and display screen 22 facing up.

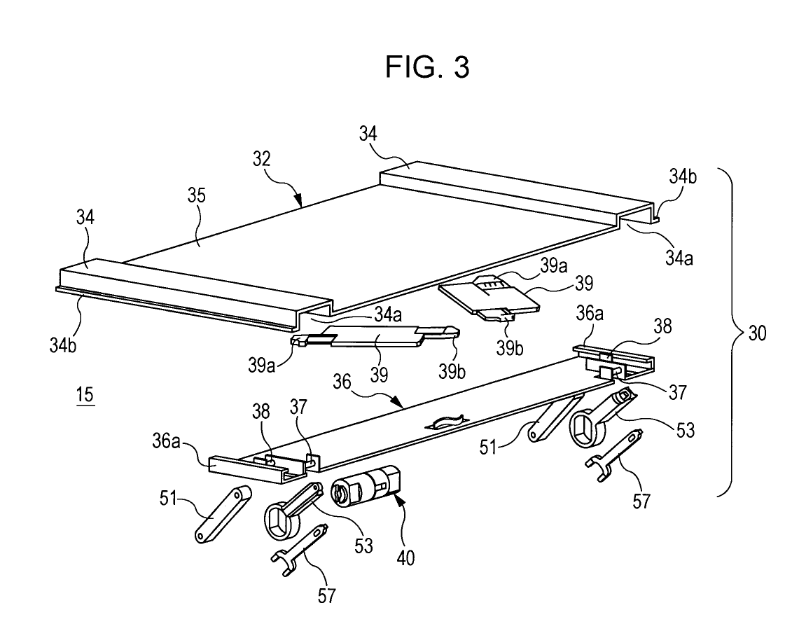

FIG. 3 is an exploded perspective view of the complex hinge module 15. The complex hinge module 15 includes a slide hinge 30, a rotational hinge 40, arm members 51 and 53, and unlocking members 57. One pair of the arm member 51 and arm member 53 is provided at each end of a movable plate 36, forming part of a link mechanism described later. Although, in this embodiment, only one rotational hinge 40 is used, which is disposed only at one end of the movable plate 36, two rotational hinges 40 may be used instead to dispose one rotational hinge 40 at each end of the movable plate 36.

The slide hinge 30 includes the movable plate 36, a support plate 32 secured to the rear surface of the second case 20, the support plate 32 linearly slidably supporting the movable plate 36, and a pair of spring members 39, which are elastic members. When the movable plate 36 is positioned on one end side of the support plate 32 with an intermediate position in the slide range of the movable plate 36 being taken as a boundary, each spring member 39 biases the movable plate 36 in a first direction toward the one end side. When the movable plate 36 is positioned on the other end side, the spring member 39 biases the movable plate 36 in a second direction toward the other end side.

More specifically, the support plate 32 is formed by bending opposing edges (shorter edges in this example) of a flat-plate-like member 35, which is rectangular and is made of a stiff material such as a metal or synthesized resin, to form slide guides 34 having a U-shaped cross section so as to form concave grooves 34a. However, the concave grooves 34a are not essential components in the present disclosure.

The movable plate 36 is a member made of a stiff material that has almost the same width as the support plate 32 but is shorter than the support plate 32 in the slide direction. A hook 36a having an L-shaped cross section is formed at each end of the movable plate 36. When the hooks 36a at the two ends of the movable plate 36 slidably fit side edges 34b, each of which extends outwardly of the slide guide 34 of the support plate 32, it becomes possible for the movable plate 36 to slide in parallel to the support plate 32 and move fore and aft.

The pair of the spring members 39 is disposed between the support plate 32 and the movable plate 36. One end of each spring member 39 is secured at a prescribed position on the support plate 32, and the other end is secured at a prescribed position on the movable plate 36. To secure the movable plate 36, caulking or another fastening means can be used. The spring member 39 is secured at these positions is rotatable around an axis perpendicular to the plate.

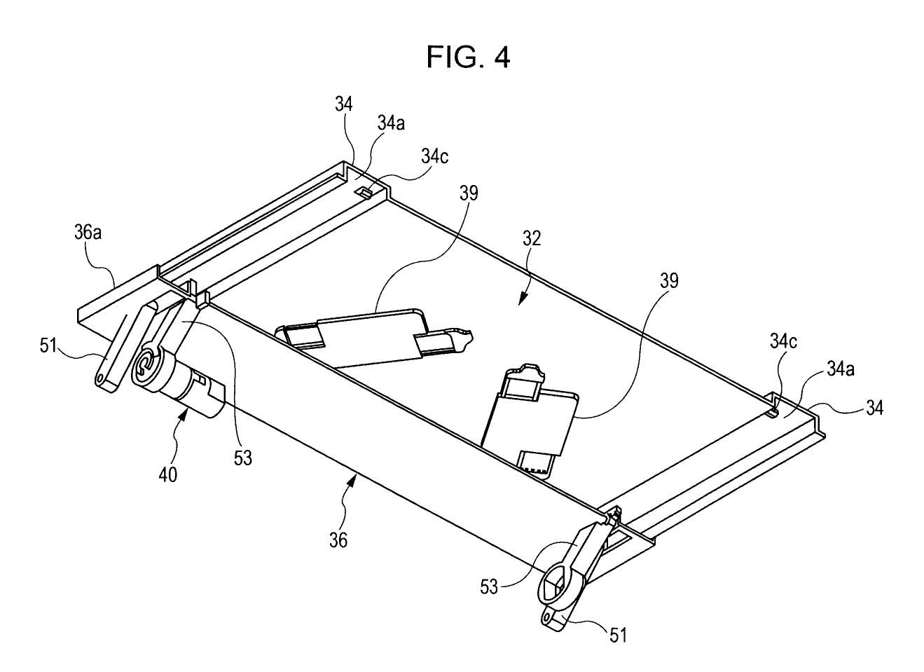

FIG. 4 is a perspective view of the complex hinge module 15 in which the disassembled parts in FIG. 3 have been assembled, as viewed from the back of the complex hinge module 15. This drawing illustrates an example in which the rotational hinge 40 is provided on only one side of the movable plate 36.

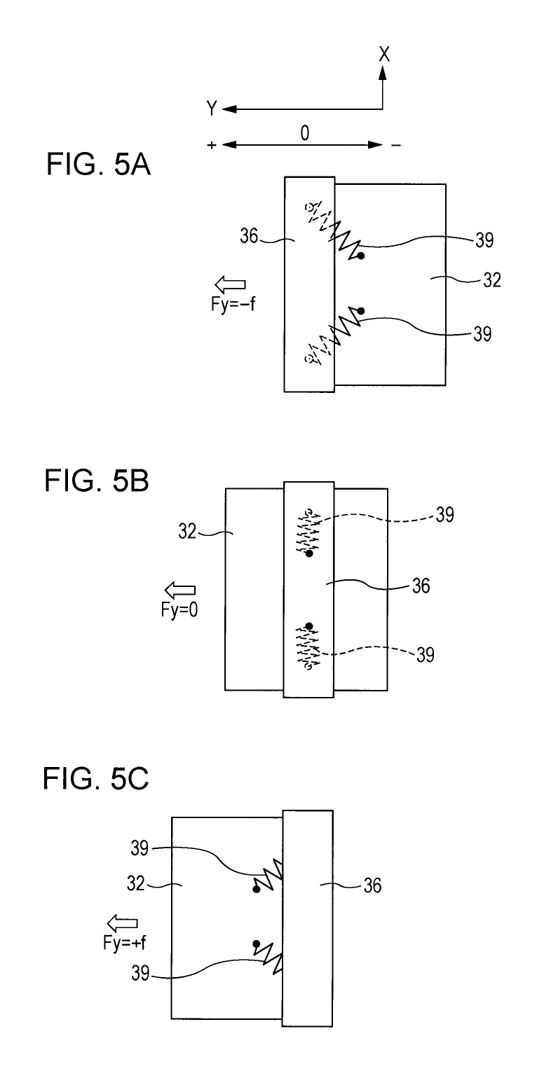

FIG. 5 gives schematic views generally illustrating the operation of the slide hinge 30. FIGS. 5A to 5C illustrate three typical positional relationships among the support plate 32, movable plate 36, and spring members 39 of the slide hinge 30. The spring member 39 is used as a compression spring, which generates a repulsive force when compressed. The operation of the slide hinge relative to the position of the movable plate 36 will be described below. FIG. 5A illustrates a state in which the movable plate 36 is positioned at one end of its movable range. This state is the first stable state, in which this positional relationship is maintained unless an external force is exerted. Even in this state, the spring members 39 are compressed to a certain extent, so there are repulsive forces. The direction in which the movable plate 36 moves is defined as the Y-axis direction. The sum of Y-axis components of the repulsive forces of the two spring members 39 is a biased force Fy, in the Y-axis direction, applied to the movable plate 36. Fy in this state is a negative value, −f.

The operations of the movable plate 36 and support plate 32 are relative. In a practical application of the slide hinge 30, the movable plate 36 may move with respect to the stationary support plate 32; conversely, the support plate 32 may move with respect to the stationary movable plate 36.

When, in the state in FIG. 5A, the support plate 32 starts to move with respect to the movable plate 36 toward the other end in the positive direction of the Y-axis (from right to left in the drawing), each spring member 39 is further compressed. The repulsive force of the spring member 39, which has generated by this compression, is increased and maximized at a position at which the spring member 39 is most compressed (nearly at the central position of the support plate 32 in this example) as illustrated in FIG. 5B. In this case, however, the repulsive force is directed in the X-axis direction perpendicular to the Y-axis direction, so the biased force Fy becomes 0. That is, this position is a dead point at which a force in the Y-axis direction is not exerted on the movable plate 36 at all; the dead point is an unstable point. When the movable plate 36 moves beyond this dead point, the spring member 39 gradually extends and the repulsive force is gradually decreased. The biased force Fy in the Y-axis direction is inverted and becomes a positive value, +f. The repulsive force continues until the opposite end of the support plate 32 is reached as illustrated in FIG. 5C. This state is the second stable state, in which this positional relationship is maintained unless an external force is exerted.

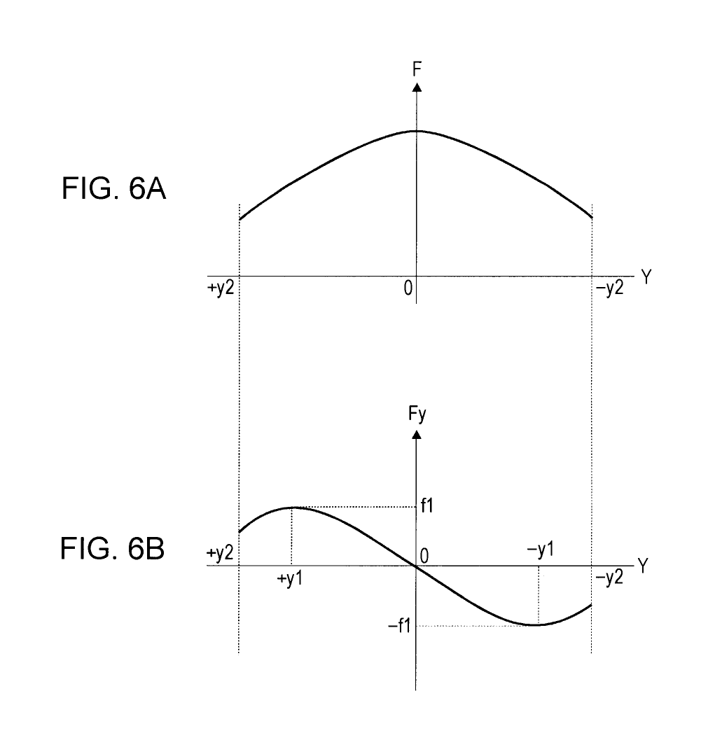

FIG. 6A illustrates a graph representing a relationship between the position Y of the movable plate 36 with respect to the support plate 32 and the elastic force (repulsive force) of each spring member 39, and FIG. 6B illustrates a graph representing a relationship between the position Y and a biased force Fy, in the Y-axis direction, which is exerted on the movable plate 36 due to the elastic force. When the movable plate 36 moves from one end of the support plate 32 to the other end, the repulsive force generated in the spring member 39 according to the change of the position Y (from −y2 to +y2) exhibits a convex shape that peaks at the central position (Y=0). By contrast, the corresponding biased force Fy is represented by a curve that resembles the letter S, the value of which changes from negative to positive at the central position; the biased force Fy peaks at positions −y1 and +y1.

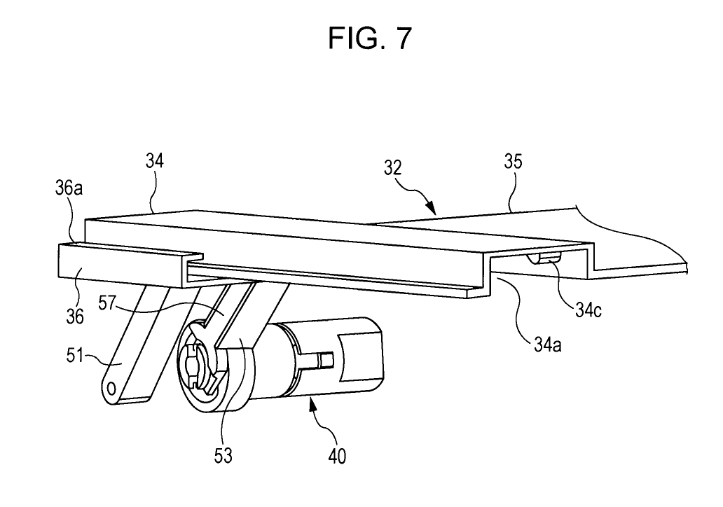

FIG. 7 is a perspective view of major parts of the complex hinge module 15 in which the disassembled parts in FIG. 3 have been assembled, as viewed from a side. As well illustrated in this drawing, a projection 34c is provided at the bottom at one end of the concave groove 34a of the slide guide 34 of the support plate 32. The projection 34c is a member forming a rotation actuating part that is an element for controlling the linkage between the slide operation and rotational operation of the complex hinge module 15 in this embodiment. The rotation actuating part has a function of unlocking the rotational hinge 40 and actuating its rotation at a position while the movable plate shifts from the first stable state to the second stable state, the position being taken immediately before the movable plate reaches the second stable state.

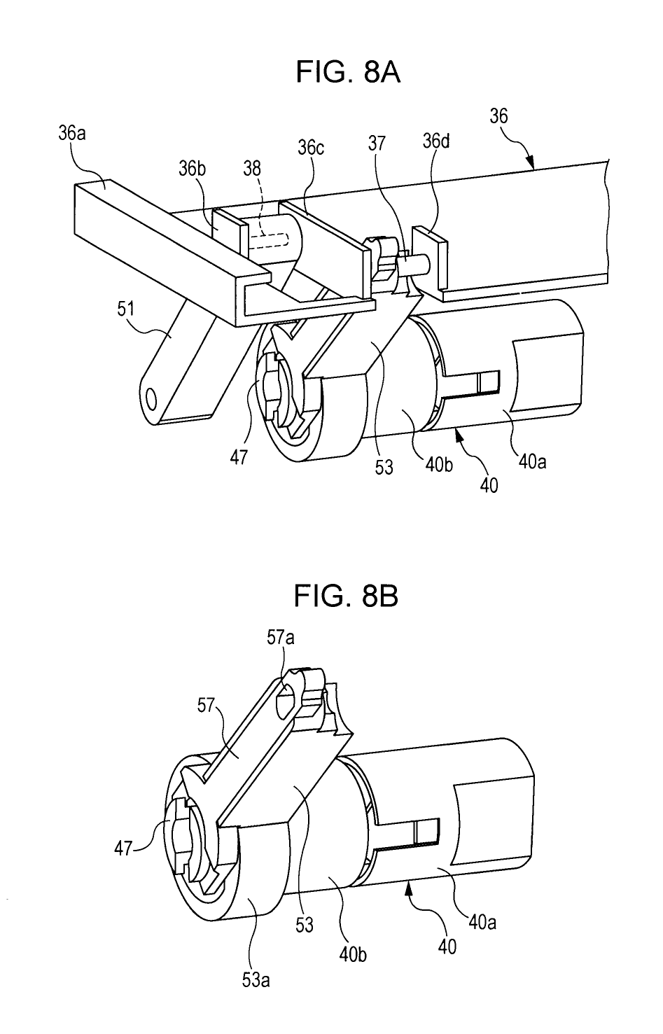

The structure in which the movable plate 36, the arm members 51 and 53, and the rotational hinge 40 are linked together will be described with reference to FIG. 8A.

One end of the arm member 51 is rotatably linked to the first case 10 and the other end is rotatably linked to the movable plate 36. In the example in the drawing, a support shaft 38 is provided, at a side of the movable plate 36, across shaft support members 36b and 36c provided so as to stand, the support shaft 38 extending along the longitudinal direction of the movable plate 36. The support shaft 38 passes through a through-hole formed at the upper end of the arm member 51.

The arm member 53 has a ring-shaped member 53a at its bottom. The ring-shaped member 53a is linked to the rotational part 40b of the rotational hinge 40, and the other end is rotatably connected to a side of the movable plate 36. When an end, the cross section of which is not circular, of the rotational part 40b of the rotational hinge 40 is fitted into a through-hole, the cross section of which is not circular, formed in the ring-shaped member 53a, the arm member 53 is linked to the rotational part 40b so as to prevent the rotational part 40b from rotating. A support shaft 37 is provided, at the side of the movable plate 36, across the shaft support member 36c and a shaft support member 36d provided so as to stand, the support shaft 37 extending along the longitudinal direction of the movable plate 36. The support shaft 37 passes through a through-hole formed at the upper end of the arm member 53. For the sake of making the support shaft 37 visible, the upper end of the arm member 53 in the drawing is cut.

The ring-shaped member 53a of the arm member 53 on the side on which the rotational hinge 40 is not disposed is connected to the first case 10 so that the arm member 53 can rotate with the ring-shaped member 53a serving as a fulcrum.

In this embodiment, the unlocking member 57 is formed with a bar member having a Y-shaped bottom. When the projection 34c (FIG. 7) formed on the support plate 32 as the rotation actuating part comes into contact with the slide hinge 30 at a position immediately before the slide hinge 30 reaches its second stable state, the unlocking member 57 transmits, to the locking member 47 of the rotational hinge 40, a force with which its lock is released.

As well illustrated in FIG. 8B, the bar of the unlocking member 57 is slidably fitted to the arm member 53 along grooves formed in the longitudinal direction of a side of the arm member 53. A through-hole 57a is formed at the upper end of the unlocking member 57. The support shaft 37 passes through the through-hole 57a and the through-hole in the arm member 53. Since the through-hole 57a in the unlocking member 57 is an elliptical hole prolonged in the longitudinal direction, however, even in a state in which the support shaft 37 passes through the through-hole 57a, the unlocking member 57 can slide in the longitudinal direction of the through-hole 57a.

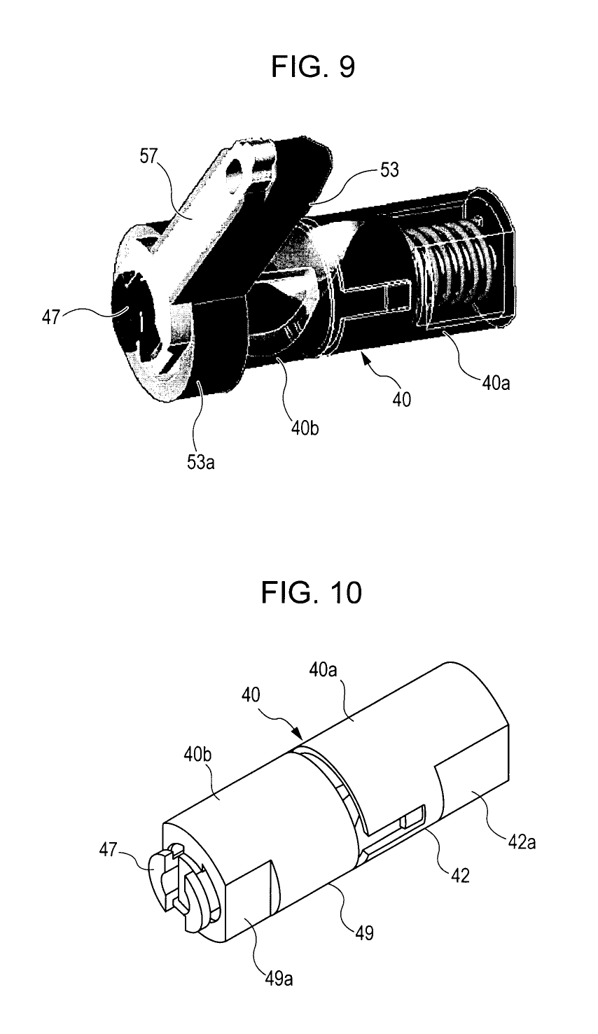

FIG. 9 is an external view of a structure in which the arm member 53 is linked to the rotational hinge 40. This drawing is a gray-scale image with the interior of the rotational hinge 40 visualized. In this drawing, the upper end, of the arm member 53, that does not have a cutout appears.

A four-node link mechanism is formed with the arm members 51 and 53, as illustrated in FIG. 8A, the movable plate 36, and the first case 10. This link mechanism has a pair of first arm members 53 and a pair of second members 51, which are connected between the movable plate 36 and the first case 10, so as to enable the movable plate 36 to move substantially in parallel to the first case 10. The end of at least one of the pair of the first arm members 53 is connected to the first case 10 through the rotational hinge 40. This link mechanism enables the second case 20 to rotate with respect to the first case 10 within the rotational range of the rotational hinge 40 while the first case 10 and movable plate 36 (by extension, the support plate 32 and the second case 20) are kept parallel to each other. The opposing links of the four-node link mechanism do not necessarily have the same length. The parallel state between the first case 10 and movable plate 36 is sufficient if the parallel state is maintained in the first stable state (locked state) and second stable state of the rotational hinge 40.

When the second case 20 slides in parallel to the first case 10 from the closed state of the mobile terminal 100 illustrated in FIG. 1A and reaches the end of the slide range, the rotational hinge 40 starts to rotate, after which the first case 10 automatically moves by rotation to a position at which the surface of the second case 20 becomes flush with the surface of the first case 10 as illustrated in FIGS. 1B and 1C.

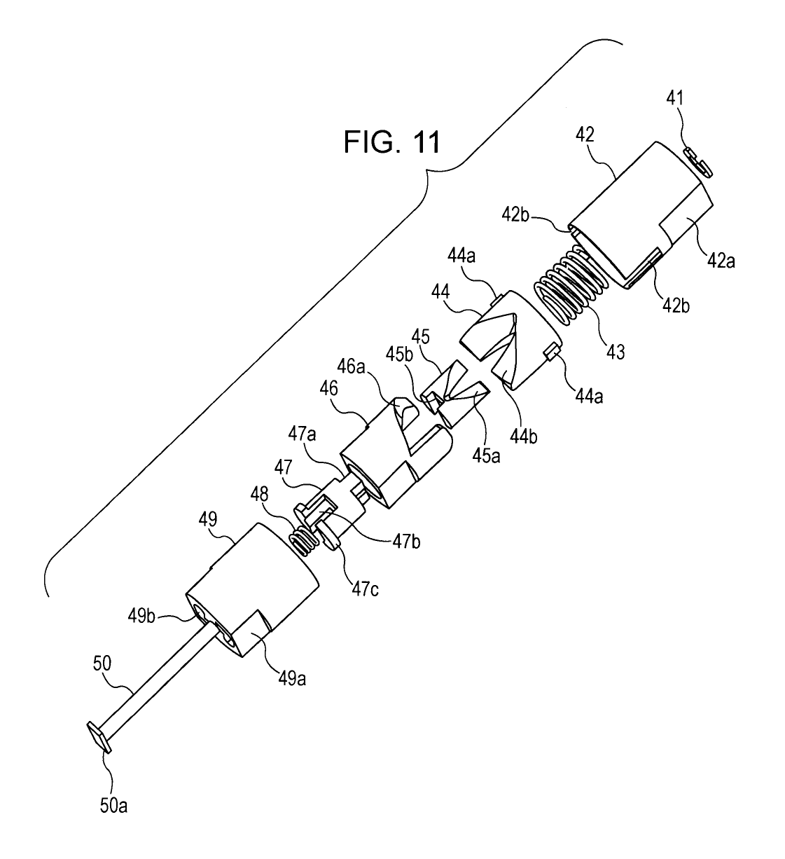

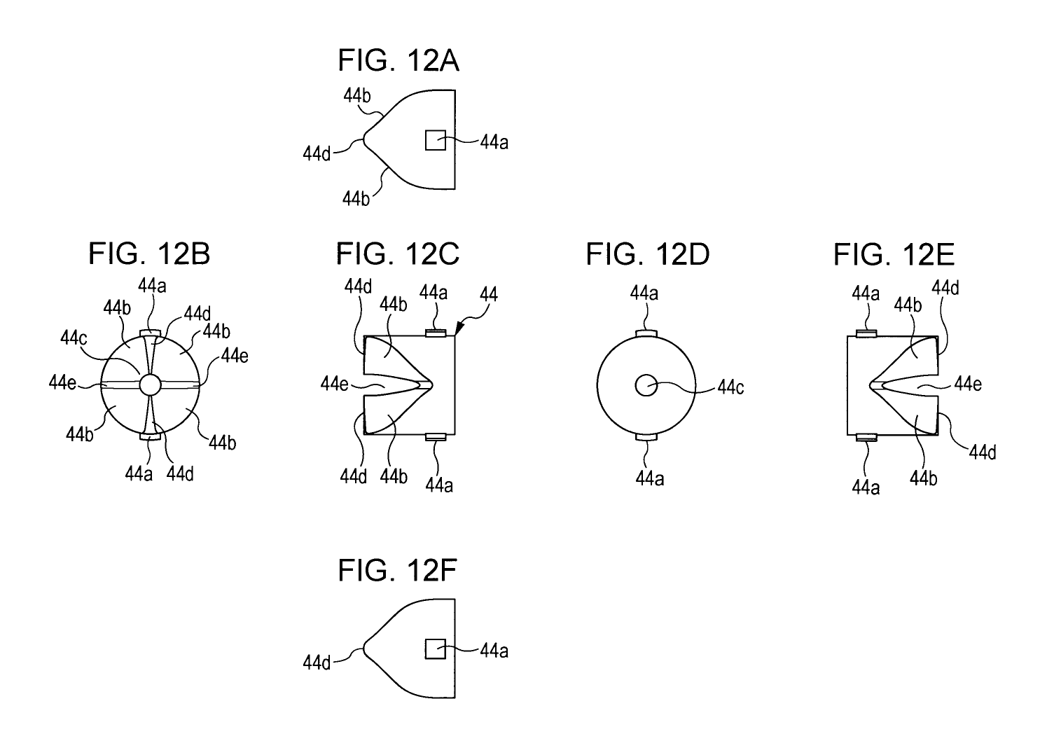

FIG. 10 is a perspective view showing the appearance of the rotational hinge 40. The rotational hinge 40 includes the fixed part 40a and rotational part 40b, which are adjacently supported on the same shaft (50 in FIG. 11) and also includes the locking member 47, which locks the rotation of the rotational part 40b at a prescribed rotational angle with respect to the fixed part 40a. The rotational part 40b is rotatable on an axis common to the fixed part 40a and rotational part 40b.

The fixed part 40a has a fixed housing 42 in a substantially cylindrical outer shape. The fixed housing 42 has cutouts 42a, which make its cross section non-circular, at two opposite positions at an end on its circumference.

The rotational part 40b has a movable housing 49 in a substantially cylindrical outer shape. Similarly, the movable housing 49 has cutouts 49a, which make its cross section non-circular, at two opposite positions at an end on its circumference. When the rotational part 40b is positioned at the prescribed rotational angle with respect to the fixed part 40a against the biased force of the internal spring or the like, the lock function of the locking member 47 is enabled. The rotation of the rotational part 40b with respect to the fixed part 40a is locked by the lock function. The internal constituent parts of the rotational hinge 40 will be described later.

When a prescribed external force is exerted on the locking member 47 with the lock function enabled (in this embodiment, the locking member 47 is pulled toward the outside along the rotational axis), the lock is released. When the lock is released, the rotational part 40b automatically rotates by a prescribed angle with respect to the fixed part 40a.

As for the fixed part 40a and rotational part 40b of the rotational hinge 40, the relation between “fixed” and “rotation” is relative. That is, it is also possible to recognize that the fixed part 40a rotates with respect to the rotational part 40b.

FIG. 11 is an exploded perspective view in which the parts constituting the rotational hinge 40 are disassembled. The rotational hinge 40 includes a fastener 41, the fixed housing 42, a spring member 43, a sliding cam 44, a rotor 45, a rotational cam 46, the locking member 47, a spring member 48, the movable housing 49, and a shaft 50. All parts other than the spring members 43 and 48 and the fastener 41 are made of rigid materials.

The shaft 50 passes through all other constituent components of the rotational hinge 40 and is engaged with the fastener 41 at its distal end. Examples of the fastener 41 are an E-ring and a C-ring. A flange 50a is provided at the proximal end of the shaft 50, the flange 50a being shaped so as to have cutouts on two sides.

The fixed housing 42 incorporates the spring member 43 and sliding cam 44 in its substantially cylindrical hollow with a bottom.

The sliding cam 44, which is part of the fixed part 40a, is slidable on the shaft 50 and is biased by an elastic force exerted in the first direction along the shaft 50. More specifically, the sliding cam 44 has a projection 44a on its outer circumference and, in the fixed housing 42, the projection 44a is supported so as to be slidable in the axial direction along a guide groove 42b formed on a side of the fixed housing 42. The sliding cam 44 is incorporated in the fixed housing 42 with the spring member 43 being compressed. The sliding cam 44 is biased by the spring member 43 toward the movable housing 49. The sliding cam 44 has cam surfaces 44b having an uneven shape on the same side as the movable housing 49.

The rotational cam 46, which is part of the rotational part 40b, is rotatably supported on the shaft 50 with the shaft 50 being used as an axis. The rotational cam 46 also functions so that it comes into contact with the sliding cam 44 and rotates as the sliding cam 44 slides. Accordingly, the rotational cam 46 is disposed on the shaft 50 with a cam surface 46a facing the cam surfaces 44b of the sliding cam 44. The rotational cam 46 has a substantially cylindrical hollow, in which the rotor 45 is incorporated.

In the rotational cam 46, the rotor 45 is rotatably supported on the shaft 50 with the shaft 50 being used as an axis. The rotor 45 functions so as to hold the sliding cam 44 in the first stable state at a prescribed angle with respect to the sliding cam 44 in cooperation with the rotational cam 46. Accordingly, the rotor 45 has cam surfaces 45a, having an uneven shape, which face the sliding cam 44. The rotor 45 also has a substantially linear engaging groove 45b at an end opposite to the cam surfaces 45a.

The locking member 47, which is slidable on the shaft 50, functions so that it is biased by an elastic force toward the sliding cam 44 and locks the rotation of the rotor 45 with respect to the rotational cam 46 and at a prescribed relative rotational angle. Accordingly, the locking member 47 has a ridge 47a at its end and is slidably inserted into the hollow of the rotational cam 46 from a side, of the rotational cam 46, that is opposite to the rotor 45. The ridge 47a is removably engaged with the engaging groove 45b of the rotor 45 in the hollow of the rotational cam 46. The locking member 47 passes through an engaging hole (not shown), in the rotational cam 46, corresponding to the ridge 47a and reaches the rotor 45. Therefore, the locking member 47 does not rotate with respect to the rotational cam 46. With the ridge 47a of the locking member 47 disengaged from the engaging groove 45b, the rotor 45 is freely rotatable in the rotational cam 46.

The locking member 47 has a flange 47c, which is divided into two parts along a cut groove 47b formed in the locking member 47 in a diameter direction, at the end at which the cut groove 47b is formed. The locking member 47 is incorporated into a substantially cylindrical hollow, with a bottom, of the movable housing 49 through the spring member 48. The two-part flange 47c passes through an opening 49b formed in the movable housing 49 and outwardly protrudes of the end of the movable housing 49. The locking member 47 is supported so as to be slidable in the axial direction within a prescribed range in the movable housing 49. In this case, the compressed spring member 48 is located between the bottom of the hollow of the movable housing 49 and the bottom of the hollow of the locking member 47. Accordingly, the locking member 47 is biased by the spring member 48 toward the rotational cam 46.

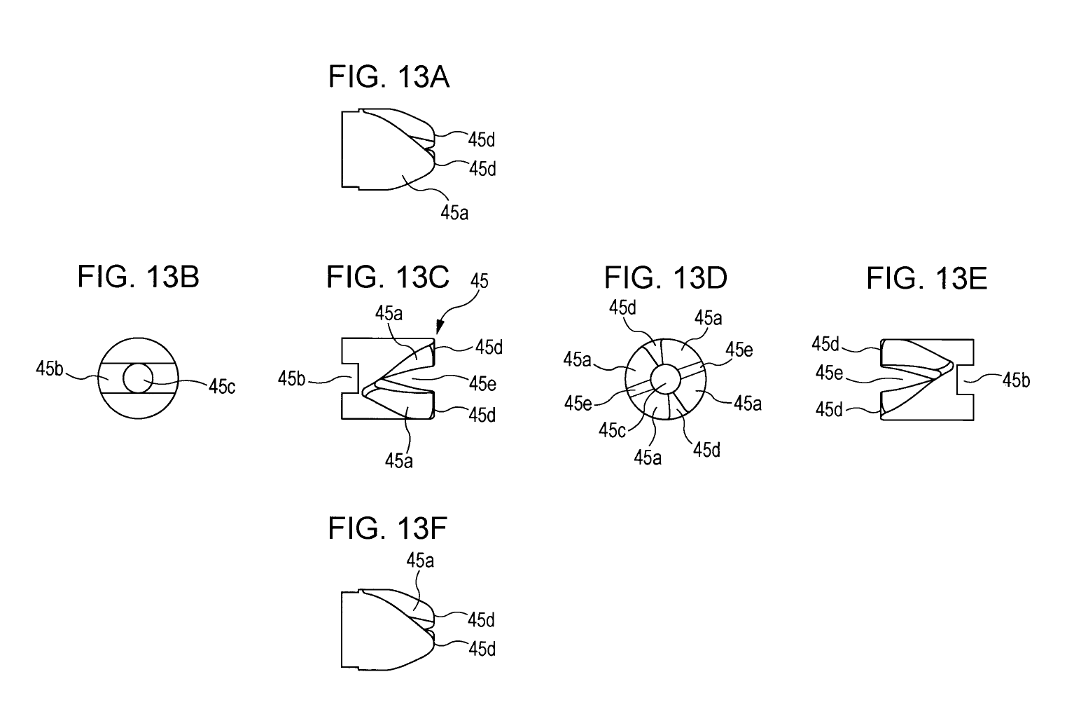

FIGS. 12, 13, and 14 are six-plane views, which respectively illustrate the appearances of the sliding cam 44, rotor 45, and rotational cam 46. In these drawings, C is a front view, A is a plan view, F is a bottom view, B is a left side view, D is a right side view, and E is a rear view.

The individual portions of the sliding cam 44 in FIG. 12 have been already described with reference to FIG. 11. In FIGS. 12B and 12D, a through-hole 44c, through which the shaft 50 passes, is clearly illustrated. The sliding cam 44 has the cam surfaces 44b, which are specific. Specifically, as well illustrated in the left-side view in FIG. 12B, the sliding cam 44 has the cam surfaces 44b, each of which is located between a top part 44d formed along a diameter direction on a cylindrical cross section and a trench 44e formed along a diameter direction perpendicular to the top part 44d.

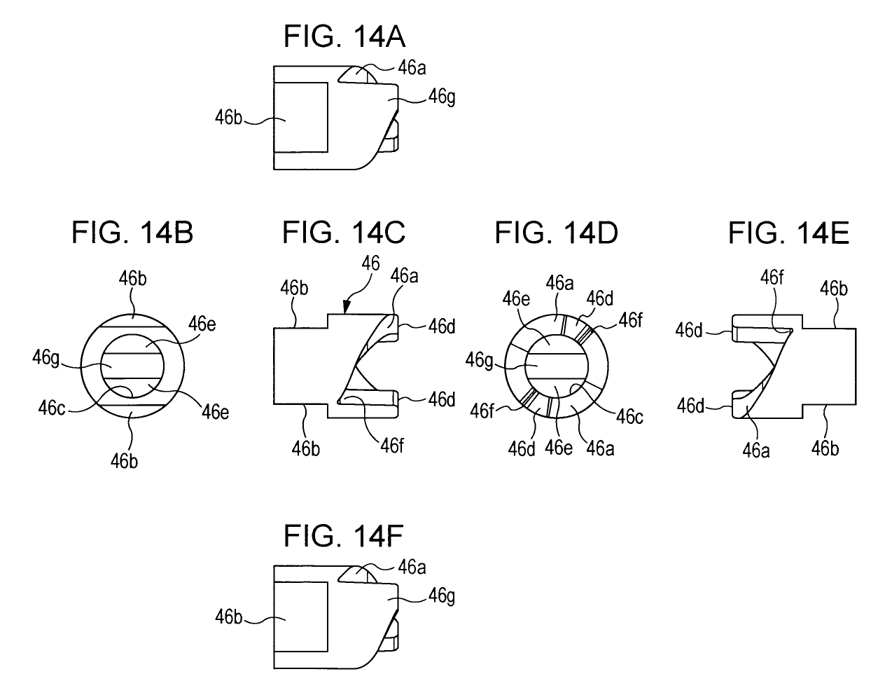

The individual portions of the rotor 45 in FIG. 13 have been already described with reference to FIG. 11. In FIGS. 13B and 13D, a through-hole 45c, through which the shaft 50 passes, is clearly illustrated. As well illustrated in FIG. 13D, the rotor 45 has the curved cam surfaces 45a, each of which is located between a top part 45d along a diameter direction on a cylindrical cross section and a trench 45e formed along a diameter direction perpendicular to the top part 45d.

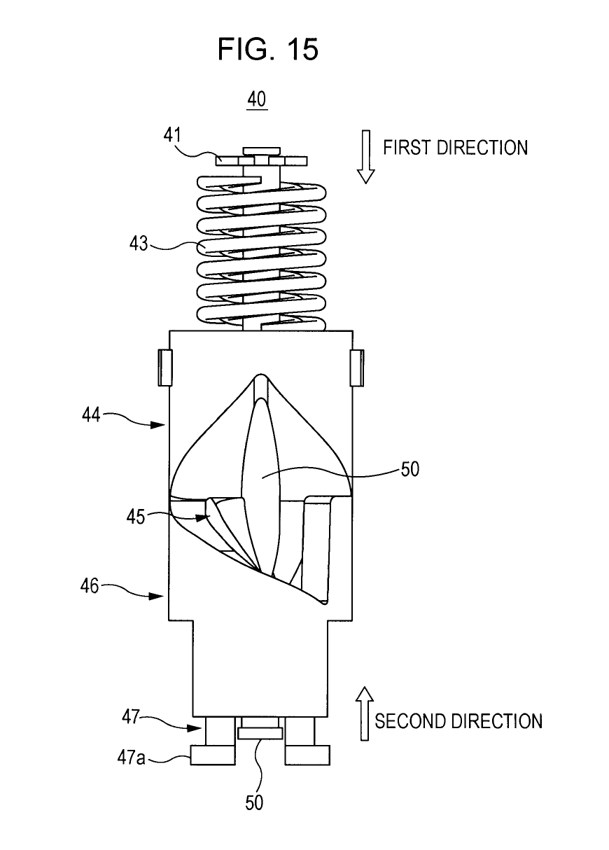

The individual portions of the rotational cam 46 in FIG. 14 have been already described with reference to FIG. 11. In FIGS. 14B and 14D, a slit-like through-hole 46g is clearly illustrated with a cylindrical hollow 46c in the rotational cam 46 and a pair of inner walls 46e that narrow the hollow 46c at an intermediate portion in the hollow 46c, the ridge 47a of the locking member 47 slidably passing through the through-hole 46g. As well illustrated in FIG. 14D, top parts 46d are provided along a diameter direction on a cylindrical cross section and bottom parts 46f are also provided, each of which is adjacent to a top part 46d. The curved cam surface 46a is formed, which is gradually lowered from one top part 46d to the bottom part 46f adjacent to the opposing top part 46d. Opposing cutouts 46b are formed on the circumference at an end opposite to the cam surface 46a of the rotational cam 46, making the cross section at the end non-circular.

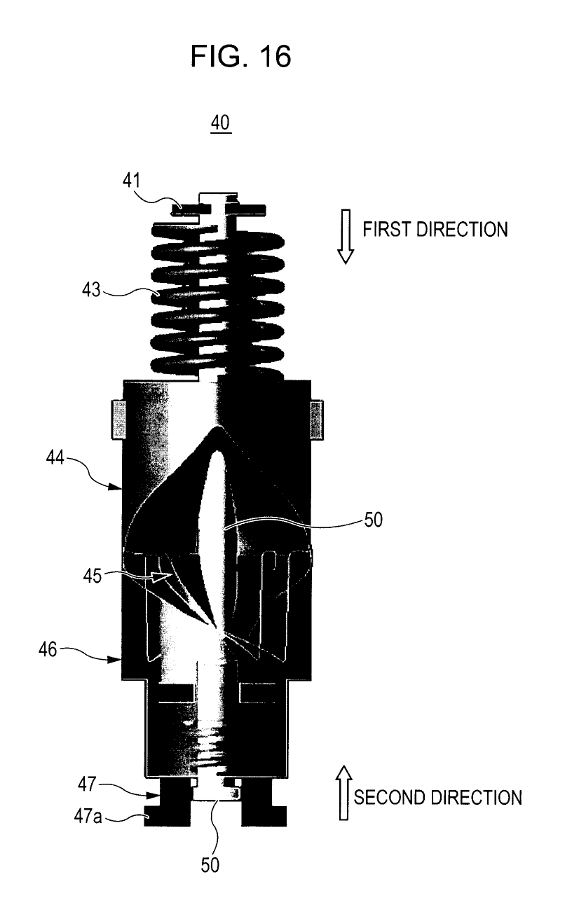

FIG. 15 is an external view of the rotational hinge 40 from which the fixed housing 42 and movable housing 49 have been removed. In the state in this drawing, the cam-shaped top part of the fixed housing 42 seats in a trench formed between the top parts of the rotational cam 46 and rotor 45, which are slightly displaced from each other, indicating a locked state. That is, the rotational cam 46 and rotor 45 are locked so that each of them does not rotate the other. The sliding cam 44 is biased in the first direction along the shaft 50, and the locking member 47 is biased in the second direction, which is opposite to the first direction.

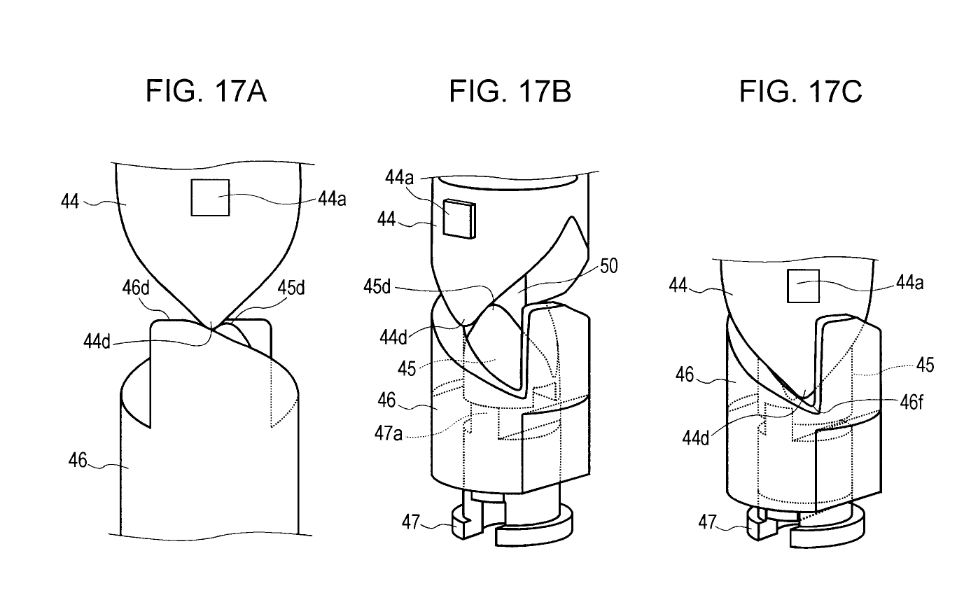

FIG. 16 is a gray-scale view that stereoscopically illustrates the rotational hinge 40 illustrated in FIG. 15.

When the rotational hinge 40 is placed in the locked state, if the locking member 47 is pulled in the downward direction in the drawing against the elastic force of the spring member 48, the rotational operation, of the rotor 45, that is locked by the locking member 47 is unlocked. Accordingly, the rotation of the rotor 45 with respect to the rotational cam 46 becomes free, and the rotational cam 46 starts to rotate in a prescribed direction in such a way that the cam-shaped top part 44d of the sliding cam 44, which has been pressed by the elastic force of the spring member 43, goes down along the cam surface 46a of the rotational cam 46. The direction of this rotation is counterclockwise as viewed from the locking member 47. Conversely, the rotor 45 rotates clockwise. The rotation of the rotational cam 46 is transmitted to the movable housing 49, causing the arm member 53 to rotate.

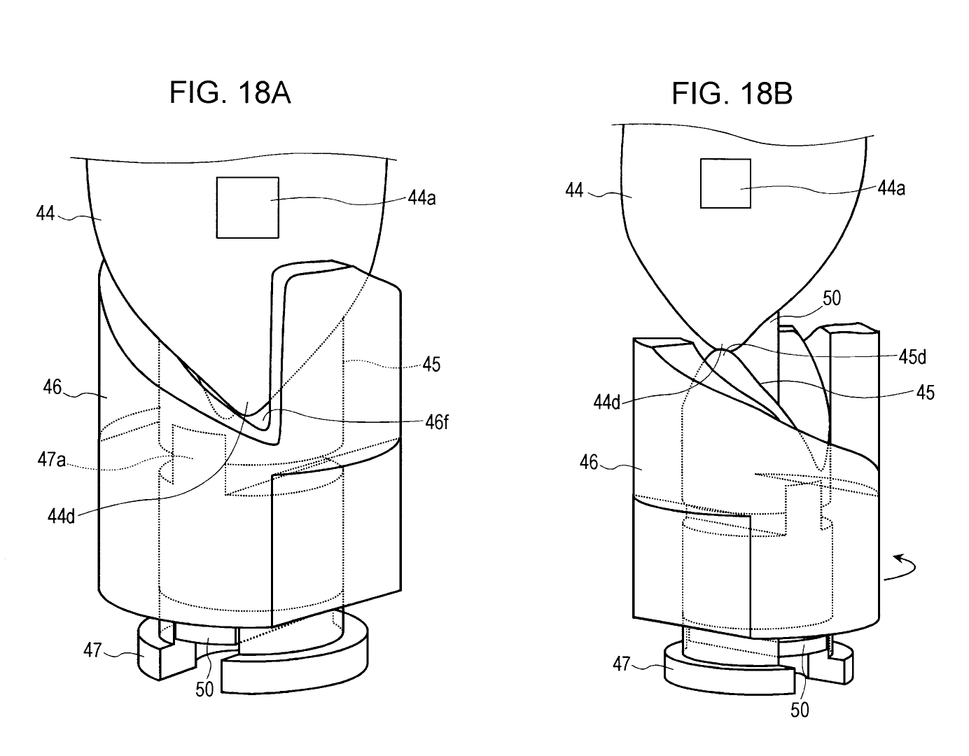

FIG. 17 gives external views illustrating a shift starting from the locked state of the rotational hinge 40. FIG. 17A illustrates the locked state. This locked state is equivalent to the first stable state of the rotational hinge 40. In this case, the top part 44d of the sliding cam 44 is positioned in the trench between the top part 46d of the rotational cam 46 and the top part 45d of the rotor 45. In this state, the rotation of the rotor 45 with respect to the rotational cam 46 is locked by the locking member 47 and the rotation of the rotational part 40b with respect to the fixed part 40a is locked. FIG. 17B illustrates a state in which the locked state has been released and the top part 44d of the sliding cam 44 is in the middle of sliding down on the inclined surface of the rotational cam 46 while the top part 44d is rotating the rotor 45 and rotational cam 46 with respect to the sliding cam 44 in the reverse direction. At that time, the ridge 47a of the locking member 47 comes off the engaging groove 45b of the rotor 45, but still remains in the engaged with the rotational cam 46. FIG. 17C illustrates a state in which the top part 44d of the sliding cam 44 has slid down to the deepest bottom part 46f of the cam shape of the rotational cam 46 (this state is the second stable state). In this example, the amount of rotation of the rotational cam 46 with respect to the sliding cam 44 from the state in FIG. 17A to the state in FIG. 17C is about 130 degrees.

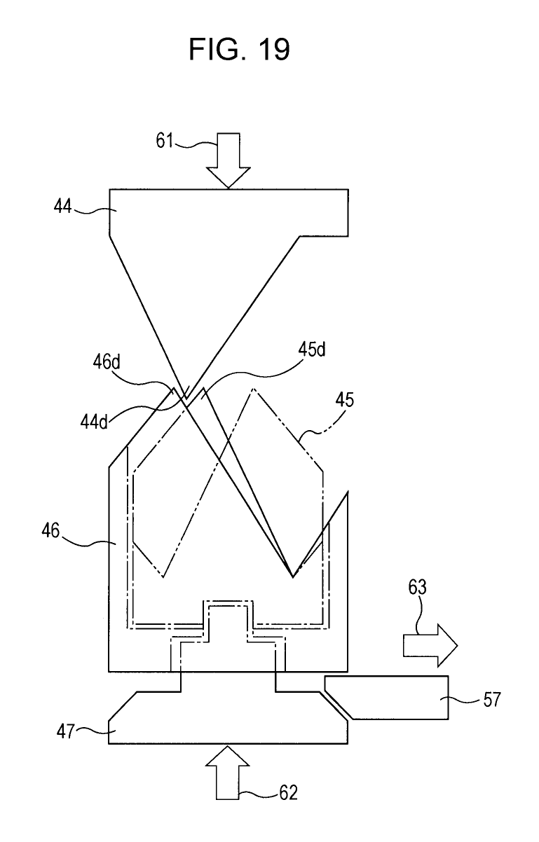

FIG. 18 gives external views illustrating a shift in which the rotational hinge returns from the state in FIG. 17C to the locked state. FIG. 18A corresponds to FIG. 17C. In the second stable state, the rotational cam 46 rotates in a direction opposite to the direction at the time of unlocking, according to an external manipulation force temporarily exerted against the elastic force. In this way, the rotational hinge 40 starts from the bottom part 46f of the rotational cam 46, reaches the trench between the top part 46d of the rotational cam 46 and the top part 45d of the rotor 45, returning to the first stable state.

More specifically, when the rotational cam 46 in the state illustrated in FIG. 18A is rotated by the user's manipulation force with respect to the sliding cam 44 in the direction indicated by the arrow, the top parts 44d of the sliding cam 44 climb the inclined surfaces of the rotor 45 and reach the top parts 45d of the rotor 45. At that time, the rotational cam 46 and rotor 45 are locked by the locking member 47 so that they do not rotate. When the top parts 44d of the sliding cam 44 move over the top parts 45d of the rotor 45, the rotational hinge 40 returns to the first stable state in FIG. 17A.

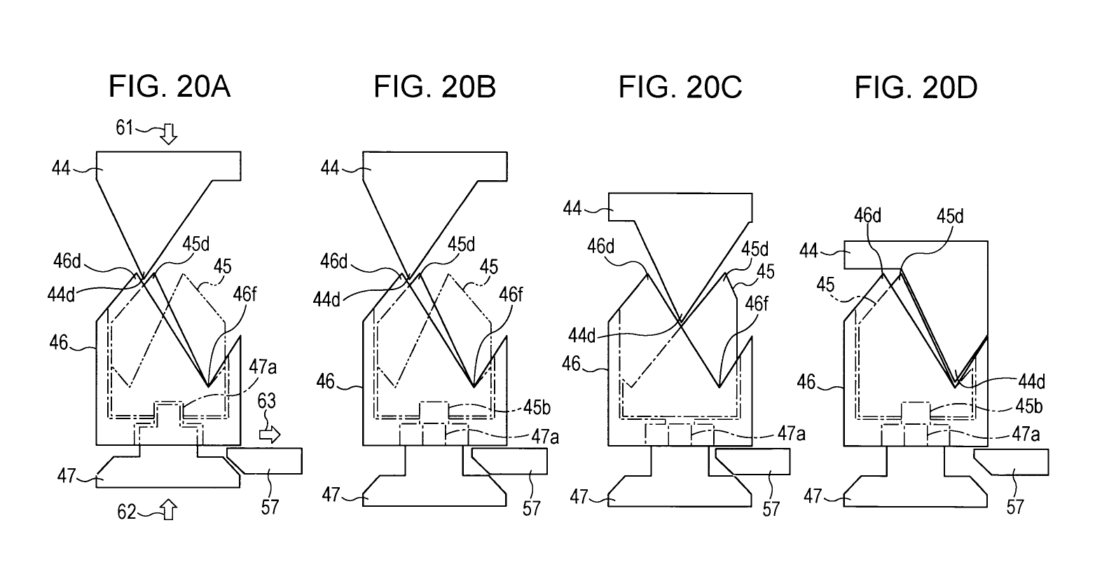

FIG. 19 is a schematic view that two-dimensionally illustrates a relationship among the main constituent components of the rotational hinge 40. The drawing illustrates a positional relationship among the sliding cam 44 in the locked state, the rotational cam 46, the rotor 45, the locking member 47, and the unlocking member 57. The three arrows in the drawing indicate the directions of biased forces 61, 62, and 63 that are respectively exerted on the sliding cam 44, locking member 47, and unlocking member 57.

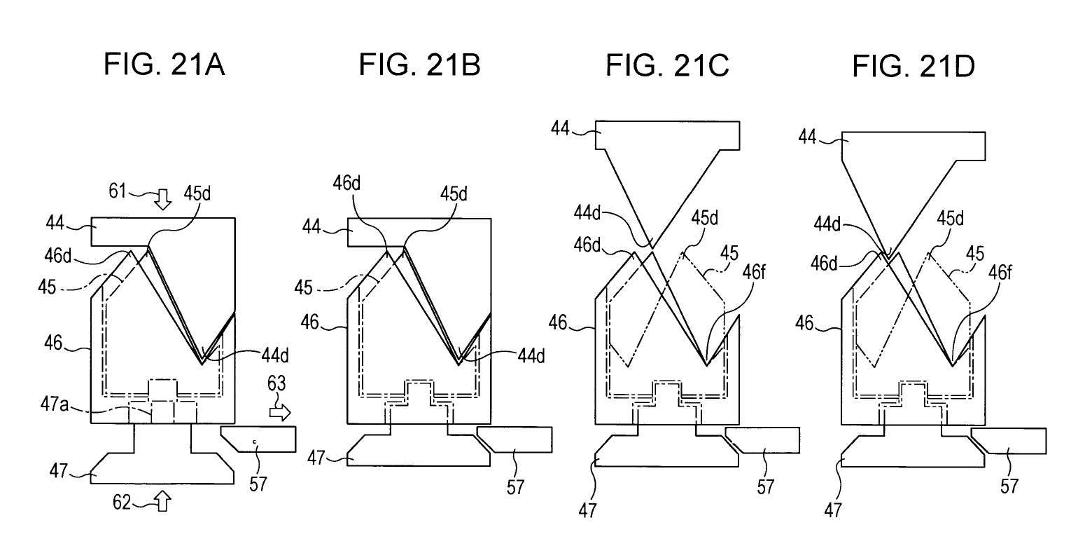

Processes of a shift from the first stable state of the rotational hinge, which corresponds to the locked state, to the second stable state of the rotational hinge, which is entered after the lock has been released, will be described with reference to FIG. 20, by using the notation in FIG. 19.

FIG. 20A corresponds to the locked state illustrated in FIG. 19. This state is the first stable state of the rotational hinge 40; this state is maintained unless any external force is exerted. Even if an external force with which the rotational hinge 40 is rotated toward the second stable state is exerted, if the external force is not large enough to cause the top parts 44d of the cam surfaces 44b of the sliding cam 44 to move over the top parts 45d of the rotor 45, the external force is canceled by the rotational force generated by cam engagement according to a biased force 61. As a result, even if an external force is exerted in a direction in which the second case 20 (upper case) in the closed state with respect to the first case 10 (lower case) is opened, the external force is cancelled. That is, in the first stable state of the rotational hinge 40, drawing torque with which the second case 20 is brought to the first case 10 due to the effect of the rotational hinge 40 is generated. As a result, backlash in the closed state, that is, backlash of the second case 20 with respect to the first case 10 in the first stable state is prevented.

The effect of the rotational hinge 40 of this type in this embodiment is obtained from a structure described below. That is, a direct biased force that causes rotation in the rotational direction is not exerted on the rotational cam 46 and any other parts of the rotational hinge 40, and the rotational force is generated by the effect of the sliding cam 44 and rotational cam 46 according to the biased force in the axial direction.

If, in the first stable state of the rotational hinge 40, the unlocking member 57 functions for the inner wall of the flange 47c of the locking member 47 according to the external force, the locking member 47 is outwardly drawn against the biased force 62. In practice, as illustrated in FIG. 8B, the Y-shaped end of the unlocking member 57 enters the space between the flange 47c of the locking member 47 and the arm member 53 so as to interrupt.

When the locking member 47 is outwardly drawn as illustrated in FIG. 20B, the rotation of the rotor 45 (by extension, the rotational cam 46) is unlocked as described above. Then, the sliding cam 44 moves inwardly along the inclination of the cam surface 46a of the rotational cam 46 according to the biased force 61, as illustrated in FIG. 20C. In the drawing, the sliding cam 44 is rotated with respect to the rotational cam 46 for the sake of convenience.

After that, the top parts 46d of the rotational cam 46 move until they reach the deepest bottom parts 46f of the cam shape of the rotational cam 46, as illustrated in FIG. 20D. Accordingly, the rotor 45 rotates through about 180 degrees from the state in FIG. 20A. This state is equivalent to the second stable state of the rotational hinge 40.

When the external force exerted on the unlocking member 57 is eliminated, the unlocking member 57 is moved back to the original position. The locking member 47 is thereby pushed inwardly again by the biased force 62. At that time, since the rotor 45 is located at a position equivalent to the rotational angle in the locked state (a position reached after a rotation of about 180 degrees), the locked state is entered again.

The rotational operation of the rotational hinge 40 actuated by the external force in FIG. 20A automatically proceeds to the state in FIG. 20D in a continuous manner.

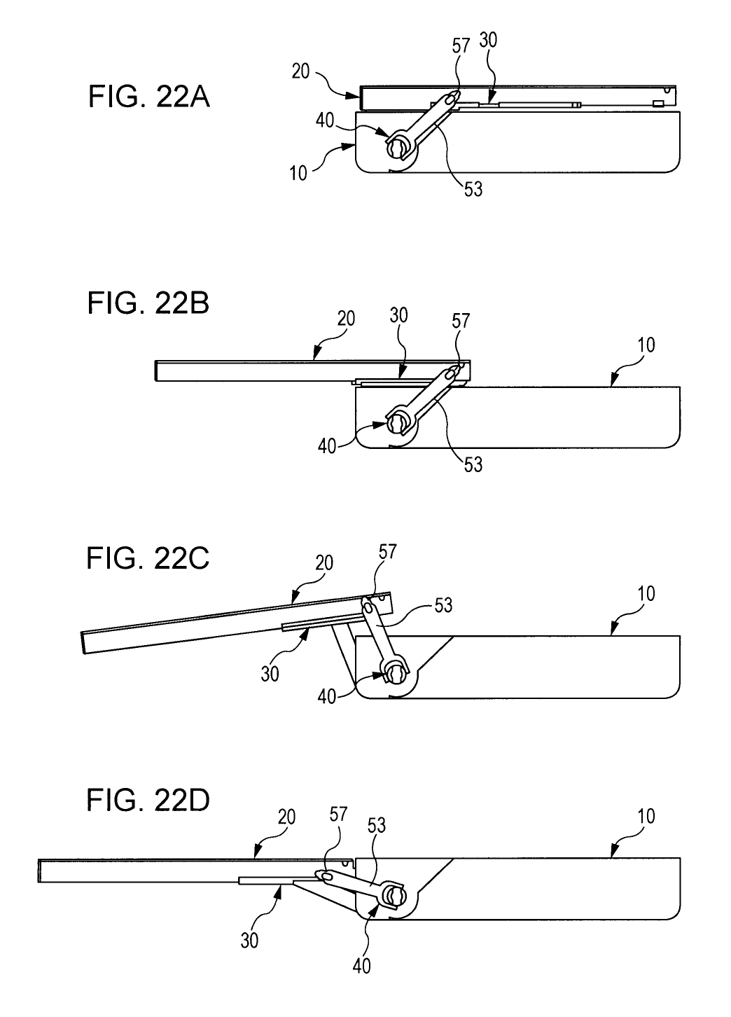

Next, processes of a shift from the second stable state of the rotational hinge 40 to the first stable state corresponding to the original locked state will be described with reference to FIG. 21, by using the notation in FIG. 19.

FIG. 21A illustrates the state in FIG. 20D. FIG. 21B illustrates a state in which the locking member 47 has returned to the original locked state. When, in this state, the rotational cam 46 is manually rotated clockwise against the biased force 61 as viewed from the locking member 47, the sliding cam 44 is retracted in the axial direction and its top parts 44d reach the top parts 45d of the rotor 45 as illustrated in FIG. 21C. In the drawing as well, the sliding cam 44 is rotated for the sake of convenience. The biased force 61 is exerted as a force with which the rotational hinge 40 is returned to the second stable state until the top parts 44d of the sliding cam 44 reach the top parts 45d of the rotor 45. Furthermore, when the rotational cam 46 slightly rotates in the same direction, the top parts 44d of the sliding cam 44 move over the top parts 45d of the rotor 45 and drop into the trenches formed between the top part 45d and the top parts 46d of the rotational cam 46, as illustrated in FIG. 21D. This means that the rotational hinge 40 has returned to its first stable state. In this state, the biased force 61 is exerted as a force with which the rotational hinge 40 is kept in its first stable state.

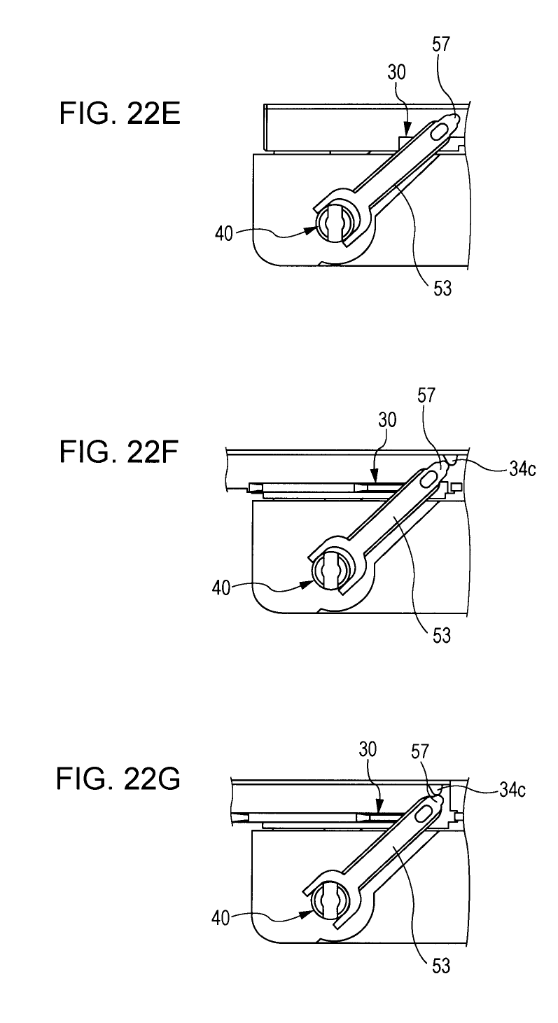

Smooth linkage between the slide operation of the slide hinge 30 and the rotational operation of the rotational hinge 40 when the mobile terminal according to this embodiment shifts from the open state to the closed state will be described with reference to FIG. 22. FIG. 22 gives schematic side views of the mobile terminal. In this drawing, the first case 10 has a cutout at a position at which the arm member 53 in front of the rotational hinge 40 is visible, for the sake of convenience.

FIG. 22A illustrates the closed state of the mobile terminal. FIG. 22E is an enlarged view of its major parts. Both the slide hinge 30 and the rotational hinge 40 are in the first stable state. Suppose that, in this state, the second case 20 has slid upward (to the left in the drawing), with respect to the first case 10, due to a manipulation force of the user along the front surface of the first case 10. At that time, the second case 20 moves against the biased force of the spring members 39. When the movable plate 36 of the slide hinge 30 passes the dead point described above, the support plate 32 and, by extension, the second case 20 then automatically shift to the second stable state of the slide hinge 30 due to the biased force, the direction of which has been inverted.

As illustrated in FIG. 22B and FIG. 22F, in which the major parts in the drawing are enlarged, the projection 34c of the support plate 32 comes into contact with the end of the unlocking member 57 at a point immediately before the first case 10 reaches the end point of the slidable range. This causes the unlocking member 57 slides forward and down along the longitudinal direction of the arm member 53 as illustrated in FIG. 22G. As a result, the Y-shaped end of the unlocking member 57 is pushed down and the locking member 47 is drawn outwardly, releasing the lock of the locking member 47 of the rotational hinge 40. This driving of the unlocking member 57 is used a trigger to shift the rotational hinge 40 from the first stable state to the second stable state as described above.

The arm member 53 and arm member 51 rotate through a prescribed angle around their rotational fulcrum on the first case 10 as the rotational hinge 40 rotates and shifts from the first stable state to the second stable state. Accordingly, the second case 20 shifts, with respect to the first case 10, from the state in FIG. 22B to the state in FIG. 22D. In the state in FIG. 22D, the surface of the second case 20 is substantially flush with the surface of the first case 10.

Accordingly, when the user starts to slide the second case 20 and moves the second case 20 by a prescribed amount, the operation of the second case 20 then automatically proceeds through the remaining slide operation and the start of a rotational operation to the end of the rotation in a continuous manner.

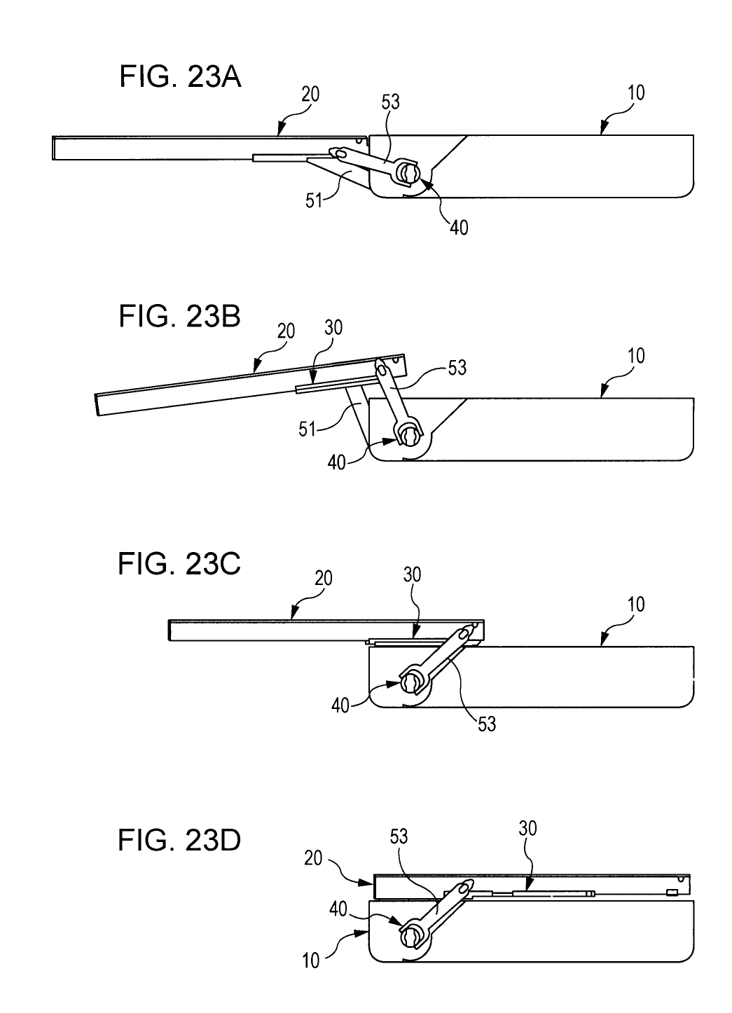

Operations in the shift of the mobile terminal in this embodiment from the open state to the closed state will be described with reference to FIG. 23.

The user carries out manipulations in two stages to shift the mobile terminal from the open state to the closed state. The first stage starts the second stable state of the rotational hinge 40 illustrated in FIG. 23A, and continues through the intermediate state of the rotational hinge 40 illustrated in FIG. 23B until the mobile terminal reaches the first stable state of the rotational hinge 40. This manipulation is manually carried out by the user against the elastic force of the rotational hinge 40. In the first stable state of the rotational hinge 40 illustrated in FIG. 23C, the rotational hinge 40 is placed in the locked state described above.

When, in the locked state, the user moves the second case 20, as the manipulation in the second stage, against the biased force of the spring member of the slide hinge 30 in a direction in which the second case 20 overlays the first case 10, the direction of the biased force of the spring member of the slide hinge 30 is reversed after the dead point described above has been passed. After that, even if the user stops the movement of the second case 20, the second case 20 automatically moves to a point at which the slide hinge 30 is closed, that is, the point, indicated in FIG. 23D, at which the second case 20 overlays the first case 10.

In this embodiment, the rotational hinge 40 is placed in the locked state at any position within the slide range of the slide hinge 30, from the state in FIG. 23C to the state in FIG. 23D. Accordingly, particularly with the mobile terminal placed in the closed state, backlash of the second case 20 with respect to the first case 10 can be effectively suppressed.

In the embodiment described above, a mobile terminal is described that has

a first case,

a second case shiftable between a closed state, in which the rear surface of the second case is overlaid on the front surface of the first case, and an open state, in which the front surface of the second case is placed next to the front surface of the first case so that the front surfaces become substantially flush with each other,

a slide hinge that includes a movable plate, a support plate that linearly slidably supports the movable plate, the support plate being secured to the rear surface of the second case, and an elastic member that biases the movable plate so that, when the movable plate is placed on one end side of the support plate with an intermediate position in the slide range of the movable plate being taken as a boundary, the movable plate moves in a direction toward a first stable state on the one end side, and that, when the movable plate is placed on the other end side, the movable plate moves in a direction toward a second stable state on the other end side, and

a rotational hinge that includes a fixed part secured to the first case, a rotational part, which is rotatable on an axis common to the fixed part and the rotational part, and an elastic member that gives a biased force with which the rotational part is rotated with respect to the fixed part, the rotational part being linked to the rotational plate through the link mechanism;

the rotational hinge further has a locking member that locks the rotation of the rotational part, with respect to the fixed part, at a predetermined angle against the biased force in a state before the rotational hinge starts; and

the support plate further has a rotation actuating part that unlocks the rotational hinge and actuates the rotation of the rotational part at a position while the movable plate shifts from the first stable state to the second stable state, the position being taken immediately before the movable plate reaches the second stable state.

It is described that, in this mobile terminal,

the rotational hinge has

a shaft,

a sliding cam, which is slidable on the shaft and is biased by an elastic force exerted in a first direction along the shaft, the sliding cam being at least part of the fixed part,

a rotational cam, rotatably supported on the shaft with the shaft being used as an axis, which comes into contact with the sliding cam and rotates as the sliding cam slides, the rotational cam being at least part of the rotational part,

a rotor, rotatably supported on the shaft with the shaft being used as an axis in the rotational cam, which holds the sliding cam in the first stable state at a prescribed angle with respect to the sliding cam in cooperation with the rotational cam, and

the locking member, slidable on the shaft, which is biased by an elastic force exerted in a second direction opposite to the first direction and locks the rotation of the rotor, with respect to the rotational cam, at a prescribed relative rotational angle;

with the rotation of the rotor with respect to the rotational cam being locked, the sliding cam is placed in the first stable state in which the top part of the sliding cam is positioned between the top parts of the rotational cam and rotor; when the lock is released by a manipulation force that is temporarily exerted against the elastic force exerted in the second direction, the sliding cam rotates the rotor through about 180 degrees to shift the rotor to the second stable state, in which the rotor is positioned at the bottom of the cam shape of the rotational cam; at that time, the rotation of the rotor with respect to the rotational cam is locked again by the locking member.

Furthermore, it is described that the mobile terminal further includes (1) a first case; a second case; and a hinge module configured to shift the first and second cases between an open state and a closed state, wherein the hinge module includes a slide hinge including a movable plate; and a support plate secured to the second case and that slidably supports the movable plate; and a rotation hinge including a fixed part secured to the first case; a rotational part configured to be rotatable on an axis common with the fixed part; an elastic member configured to provide the rotational part with a biased force to rotate the rotational part with respect to the fixed part; a link mechanism that connects the rotational part with the movable plate; and a locking member configured to lock the rotation of the rotational part with respect to the fixed part at a predetermined angle, wherein the support plate further includes a rotation actuating part configured to unlock the locking member so that the rotational part rotates with respect to the fixed part.

(2) The mobile terminal of (1), wherein a rear surface of the second case is overlaid on a front surface of the first case in the closed state.

(3) The mobile terminal of (1) or (2), wherein a front surface of the second case is placed next to a front surface of the first case so that the front surface of the first case and the front surface of the second case are substantially flush with each other in the open state.

(4) The mobile terminal of any one of (1) to (3), wherein the support plate is secured to a rear surface of the second case.

(5) The mobile terminal of any one of (1) to (4), further comprising: a second elastic member that provides the movable plate with a biased force so that when the movable plate is placed at one end side of the support plate with an intermediate position in a slide range of the movable plate taken as a boundary, the movable plate moves in a direction toward a first stable state on the one end side, and when the movable plate is placed on another end side of the support plate, the movable plate moves in a direction toward a second stable state on the another end side.

(6) The mobile terminal of (5), wherein the rotation actuating part unlocks the locking member so that the rotational part rotates with respect to the fixed part at a position while the movable plate shifts from the first stable state to the second stable state, the position being taken immediately before the movable plate reaches the second stable state.

(7) The mobile terminal of (6), wherein the rotational hinge further includes a shaft and a sliding cam, wherein the sliding cam is part of the fixed part.

(8) The mobile terminal of (7), wherein the sliding cam is slidable on the shaft and is biased by a force exerted in a first direction along the shaft.

(9) The mobile terminal of (8), further comprising: a rotational cam that is rotatably supported on the shaft with the shaft being used as an axis for the rotational cam, wherein the rotational cam is part of the rotational part.

(10) The mobile terminal of (9), wherein the rotational cam is in contact with the sliding cam and rotates as the sliding cam slides.

(11) The mobile terminal of (10), further comprising: a rotor rotatably supported on the shaft with the shaft being used as an axis in the rotational cam.

(12) The mobile terminal of (11), wherein the rotor holds the sliding cam in the first stable state at a prescribed angle with respect to the sliding cam in cooperation with the rotational cam and the locking member, slidable on the shaft, which is biased by an elastic force exerted in a second direction opposite to the first direction and locks rotation of the rotor with respect to the rotational cam at a prescribed relative rotational angle.

(13) The mobile terminal of (12), wherein with the rotation of the rotor with respect to the rotational cam being locked, the sliding cam is placed in the first stable state, in which a top part of the sliding cam is positioned between top parts of the rotational cam and the rotor.

(14) The mobile terminal of (13), wherein when the lock is released by a manipulation force temporarily exerted against the elastic force exerted in the second direction, the sliding cam rotates the rotor through approximately 180 degrees to shift the rotor to the second stable state, in which the rotor is positioned at a bottom of a cam shape of the rotational cam.

Although a preferred embodiment of the present invention has been described, various variations and modifications can be made besides the above descriptions. That is, it will be understood by those skilled in the art that various modification and combinations and other embodiments may be derived from design or other elements within the range of the claims of the present invention or an equivalent range of the claims.

For example, the mobile terminal according to the present invention may include mobile telephone terminals, mobile information terminals (including so-called smart phones), mobile game machines, mobile personal computers (PCs), digital cameras, electronic dictionaries, and any other terminals.

Although, in order to link the operations of the slide hinge 30 and rotational hinge 40 together, the unlocking member 57 has been used as a member that transmits a lock releasing force to unlock the rotational hinge 40, the specific shape and effect of this member are not necessarily limited to the shape and effect described above.

Although a spring has been used as an elastic member, this is not a limitation; any members generating an elastic force can be used.

Although the first case and the second case have been described for a mobile terminal having a display screen (display device) on the front surface of each of the first case and the second case, the two cases do not necessarily have to have a display screen. For example, one case may have another functional part such as a keyboard.

1. A mobile terminal comprising:
a first case;
a second case; and
a hinge module configured to shift the first and second cases between an open state and a closed state, wherein the hinge module includes
a slide hinge including
a movable plate; and
a support plate secured to the second case and that slidably supports the movable plate; and
a rotation hinge including
a fixed part secured to the first case;
a rotational part configured to be rotatable on an axis common with the fixed part;
an elastic member configured to provide the rotational part with a biased force to rotate the rotational part with respect to the fixed part;
a link mechanism that connects the rotational part with the movable plate; and
a locking member configured to lock the rotation of the rotational part with respect to the fixed part at a predetermined angle, wherein
the support plate further includes a rotation actuating part configured to unlock the locking member so that the rotational part rotates with respect to the fixed part.

2. The mobile terminal of claim 1, wherein
a rear surface of the second case is overlaid on a front surface of the first case in the closed state.

3. The mobile terminal of claim 1, wherein
a front surface of the second case is placed next to a front surface of the first case so that the front surface of the first case and the front surface of the second case are substantially flush with each other in the open state.

4. The mobile terminal of claim 1, wherein
the support plate is secured to a rear surface of the second case.

5. The mobile terminal of claim 1, further comprising:
a second elastic member that provides the movable plate with a biased force so that when the movable plate is placed at one end side of the support plate with an intermediate position in a slide range of the movable plate taken as a boundary, the movable plate moves in a direction toward a first stable state on the one end side, and when the movable plate is placed on another end side of the support plate, the movable plate moves in a direction toward a second stable state on the another end side.

6. The mobile terminal of claim 5, wherein
the rotation actuating part unlocks the locking member so that the rotational part rotates with respect to the fixed part at a position while the movable plate shifts from the first stable state to the second stable state, the position being taken immediately before the movable plate reaches the second stable state.

7. The mobile terminal of claim 6, wherein
the rotational hinge further includes a shaft and a sliding cam, wherein the sliding cam is part of the fixed part.

8. The mobile terminal of claim 7, wherein
the sliding cam is slidable on the shaft and is biased by a force exerted in a first direction along the shaft.

9. The mobile terminal of claim 8, further comprising:
a rotational cam that is rotatably supported on the shaft with the shaft being used as an axis for the rotational cam, wherein the rotational cam is part of the rotational part.

10. The mobile terminal of claim 9, wherein
the rotational cam is in contact with the sliding cam and rotates as the sliding cam slides.

11. The mobile terminal of claim 10, further comprising:
a rotor rotatably supported on the shaft with the shaft being used as an axis in the rotational cam.

12. The mobile terminal of claim 11, wherein
the rotor holds the sliding cam in the first stable state at a prescribed angle with respect to the sliding cam in cooperation with the rotational cam and the locking member, slidable on the shaft, which is biased by an elastic force exerted in a second direction opposite to the first direction and locks rotation of the rotor with respect to the rotational cam at a prescribed relative rotational angle.

13. The mobile terminal of claim 12, wherein
with the rotation of the rotor with respect to the rotational cam being locked, the sliding cam is placed in the first stable state, in which a top part of the sliding cam is positioned between top parts of the rotational cam and the rotor.

14. The mobile terminal of claim 13, wherein
when the lock is released by a manipulation force temporarily exerted against the elastic force exerted in the second direction, the sliding cam rotates the rotor through approximately 180 degrees to shift the rotor to the second stable state, in which the rotor is positioned at a bottom of a cam shape of the rotational cam.
